(19) United States
(12) Patent Application Publication
(10) Pub. No.: US 2026/0055125 A1
(43) Pub. Date: Feb. 26, 2026

(54) LIGAND-ASSISTED DEOXYGENATION OF PHOSPHATES TO FORM NITROGEN-CONTAINING PHOSPHORUS(V) PRECURSORS AND THEIR SUBSEQUENT CONVERSION TO VARIOUS OXYPHOSPHORUS COMPOUNDS

(71) Applicant: TECHNISCHE UNIVERSITÄT DRESDEN, Dresden (DE)

(72) Inventors: Jan Weigand, Dresden (DE); Kai Schwedtmann, Dresden (DE); Robin Schoemaker, Dresden (DE); Stephen Schulz, Dresden (DE)

(21) Appl. No.: 18/710,335

(22) PCT Filed: Nov. 17, 2022
(86) PCT No.: PCT/EP2022/082279

§ 371 Date: May 15, 2024

(30) Foreign Application Priority Data
Nov. 19, 2021 (EP) 21209296.9

(51) Int. Cl. C07F 9/58

(52) U.S. Cl. CPC C07F 9/58

(57) ABSTRACT

The present invention relates to a method for synthesising nitrogen-containing phosphorus(V) precursors of formula (I), wherein a phosphate compound is reacted with an oxygen acceptor based on a sulfonic anhydride in the presence of a Lewis base L_{N} capable of coordination via a nitrogen atom, wherein the Lewis base L_{N} is a nitrogen-containing heteroaromatic compound containing a six-membered heteroaromatic ring. The present invention also relates to a method for synthesising oxyphosphorus compounds, wherein the method for synthesising nitrogen-containing phosphorus(V) precursors of formula (I) is carried out and the nitrogen-containing phosphorus(V) precursor of formula (I) is reacted with a nucleophile.

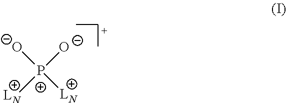

Phosphorus is essential as molecular building block for all forms of life, it is a central component in worldwide food production, and it has countless applications in industry (see W. Schipper, Eur. J. Inorg. Chem. 2014, 1567) as well in the areas of basic research and application-oriented research at universities and research institutes.

Against this backdrop, the current depletion and exploitation of the available phosphorous resources is extremely worrying. Phosphorus resources are already considered by the European Commission to be critical raw materials (see European Commission, Report of the Ad hoc Working Group on defining critical raw materials: Report on Critical Raw Materials for the EU Ref. Ares, 2015, 1819503-Apr. 4, 2015). Moreover, current synthesis methods for the production of most phosphorus compounds are resource-inefficient, energy-intensive, and require hazardous and toxic reagents (see a) Emsley, J. The 13th Element: The Sordid Tale of Murder, Fire, and Phosphorus; John Wiley & Sons, Inc.: New York, 2000; b) H. Diskowski, T. Hofmann, “Phosphorus,” Ullmann's Encyclopedia of Industrial Chemistry (Wiley, 2000); c) K. Schrödter et al., “Phosphoric Acid and Phosphates,” Ullmann's Encyclopedia of Industrial Chemistry (Wiley, Weinheim, Germany, 2008); d) O. Gantner, W. Schipper, J.J. Weigand, in Sustainable Phosphorus Management, 1st ed. (Eds.: R.W. Scholz, A.H. Roy, F.S. Brand, D. Hellums, A. E. Ulrich), Springer Netherlands, 2014; e) H. Ohtake, S. Tsuneda, Phosphorus

Recovery and Recycling, Springer, Singapore, 2018).

The natural but non-renewable resource of all phosphorus compounds is phosphate rock, such as apatite (Ca₅(PO₄)₃(F, OH, Cl)). Phosphorus is present here in its most stable oxidation state +V as phosphate (PO₄³⁻).

In this context, one speaks of primary phosphorus resources. Secondary phosphorus resources are those made available by recycling.

The vast majority of industrially relevant phosphorus-containing products, such as pharmaceuticals, fertilizers, flame retardants, pesticides and food or drug additives, etc. have the central phosphorus atom in its most stable oxidation state +V (see a) Emsley, J. The 13th Element: The Sordid Tale of Murder, Fire, and Phosphorus; John Wiley & Sons, Inc.: New York, 2000; b) H. Diskowski, T. Hofmann, “Phosphorus,” Ullmann's Encyclopedia of Industrial Chemistry (Wiley, 2000); c) K. Schröder et al., “Phosphoric Acid and Phosphates,” Ullmann's Encyclopedia of Industrial Chemistry (Wiley, Weinheim, Germany, 2008); J.L. Jones, Y.G. Yingling, I.M. Reaney, P. Westerhoff, MRS Bull. 2020, 45, 7). These phosphorus(V) compounds can be classified according to the number of oxygen atoms bonded to the phosphorus atom, i.e. as phosphates (PO₄³⁻), phosphonates (RPO₃²⁻), phosphinates (R₂PO₂⁻) and phosphane oxides (R₃PO).

The majority of the phosphate mineral mined today is used for the synthesis of phosphoric acid (H₃PO₄) for the fertilizer industry. Synthesis is usually carried out by the so-called wet process. In this process, raw phosphate is broken down with mineral acids (sulfuric, hydrochloric, or nitric acid). In this method, large amounts of byproducts are produced.

Alternatively, phosphoric acid can be obtained from the electrothermal reduction of phosphate rock to white phosphorus (P₄). White phosphorus is the most important industrial phosphorus source for food production, as well as for pharmaceutical, agricultural and numerous other industrial applications. White phosphorus (P₄) is burned to obtain phosphorus pentoxide (P₄O₁₀), followed by hydrolysis (so-called thermal phosphoric acid).

With the exception of relatively inferior phosphoric acid (H₃PO₄), which is obtained by the above-mentioned wet process, the synthetically relevant phosphorus is reduced in the thermal method to P₄, and taking this as a starting point, either oxidized to P₄O₁₀, chlorinated to PCl₃, or oxychlorinated to OPCl₃.

These three phosphorus compounds (P₄O₁₀, PCl₃, OPCl₃) constitute the most important synthetically relevant phosphorus sources (see a) Emsley, J. The 13th Element: The Sordid Tale of Murder, Fire, and Phosphorus; John Wiley & Sons, Inc.: New York, 2000; b) H. Diskowski, T. Hofmann, “Phosphorus,” Ullmann's Encyclopedia of Industrial Chemistry (Wiley, 2000); c) K. Schrödter et al., “Phosphoric Acid and Phosphates,” Ullmann's Encyclopedia of Industrial Chemistry (Wiley, Weinheim, Germany, 2008); d) O. Gantner, W. Schipper, J.J. Weigand, in Sustainable Phosphorus Management, 1st ed. (Eds.: R.W. Scholz, A.H. Roy, F.S. Brand, D. Hellums, A.E. Ulrich), Springer Netherlands, 2014; e) H. Ohtake, S. Tsuneda, Phosphorus Recovery and Recycling, Springer, Singapore, 2018).

Among the various intermediates of the further synthesis steps, the most important source of phosphorus(III) is phosphorus trichloride (PCl₃). This is a corrosive, toxic, and volatile liquid. Phosphorus trichloride is used in subsequent transformation reactions such as hydrolysis, alcoholysis, and salt metathesis in order to obtain industrially important phosphorus chemicals as well as fine chemicals for academic use. In these transformation reactions, the chorine atoms of the PCl₃ are accepted as waste in the form of salt load or in the form of corrosive gases (e.g. HCl), which conflicts with modern and atom-economic application (see a) Emsley, J. The 13th Element: The Sordid Tale of Murder, Fire, and Phosphorus; John Wiley & Sons, Inc.: New York, 2000; b) H. Diskowski, T. Hofmann, “Phosphorus,” Ullmann's Encyclopedia of Industrial Chemistry (Wiley, 2000); c) K. Schrödter et al., “Phosphoric Acid and Phosphates,” Ullmann's Encyclopedia of Industrial Chemistry (Wiley, Weinheim, Germany, 2008); d) O. Gantner, W. Schipper, J. J. Weigand, in Sustainable Phosphorus Management, 1st ed. (Eds.: R. W. Scholz, A. H. Roy, F. S. Brand, D. Hellums, A. E. Ulrich), Springer Netherlands, 2014; e) H. Ohtake, S. Tsuneda, Phosphorus Recovery and Recycling, Springer, Singapore, 2018).

The final steps for forming industrially relevant oxyphosphorus compounds comprise alcoholysis or hydrolysis, the Arbuzov reaction, or the Grignard reaction. The relevant reaction steps are shown in Diagram 1 below.

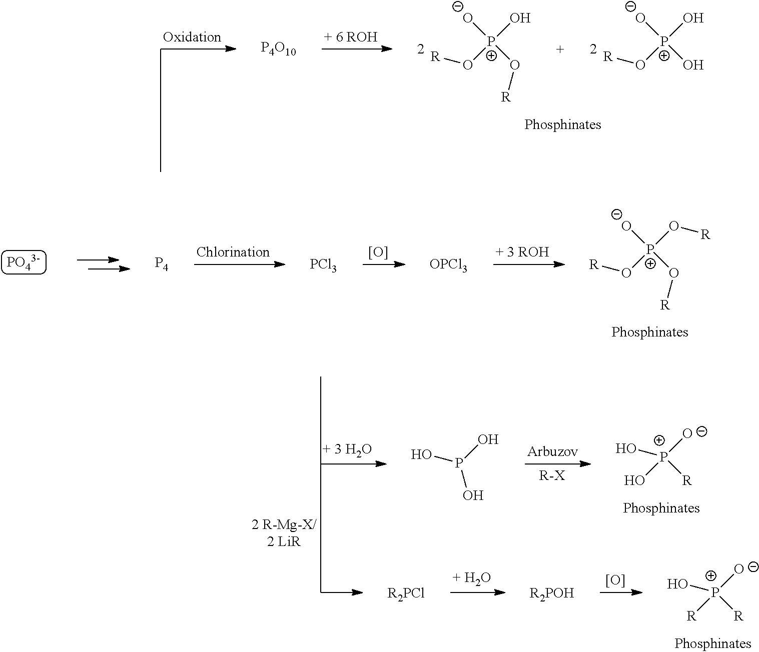

Diagram 1: Synthesis of Industrial and Research-Related Oxyphosphorus Compounds.

In these reactions, large amounts of waste are produced. In addition, today's phosphorus chemistry consumes huge amounts of energy in order to first reduce (P₄) the non-renewable raw material phosphate (PO₄³⁻) and then chlorinate it (PCl₃) or reoxidize it (P₄O₁₀, POCl₃).

In summary, it can be said that because of the electrothermal process followed by oxidation, chlorination or oxychlorination, the processing of phosphate ore today is highly energy-intensive and produces large amounts of waste. In this process, the phosphate ore is first reduced to P₄ at high cost, after which this is converted into the basic chemicals P₄O₁₀, PCl₃ and OPCl₃. Phosphorus trichloride (PCl₃) and phosphoryl chloride (OPCl₃) are corrosive, toxic, and volatile liquids. These compounds are used in subsequent transformation reactions such as hydrolysis, alcoholysis and salt metathesis in order to obtain phosphorus chemicals and fine chemicals for the academic and pharmaceutical fields. Ultimately, a large portion of the chlorine atoms generated by chlorination of P₄ with chlorine gas end up in waste salts that have no commercial value.

The known methods are thus above all highly energy-intensive, difficult to handle because of the use of corrosive, toxic, and volatile liquids or gases, and produce large amounts of waste. This continues to be one of the largest problems in phosphorus chemistry (see a) Emsley, J. The 13th Element: The Sordid Tale of Murder, Fire, and Phosphorus; John Wiley & Sons, Inc.: New York, 2000; b) H. Diskowski, T. Hofmann, “Phosphorus,” Ullmann's Encyclopedia of Industrial Chemistry (Wiley, 2000); c) K. Schrödter et al., “Phosphoric Acid and Phosphates,” Ullmann's Encyclopedia of Industrial Chemistry (Wiley, Weinheim, Germany, 2008); d) O. Gantner, W. Schipper, J. J. Weigand, in Sustainable Phosphorus Management, 1st ed. (Eds.: R. W. Scholz, A. H. Roy, F. S. Brand, D. Hellums, A. E. Ulrich), Springer Netherlands, 2014; e) H. Ohtake, S. Tsuneda, Phosphorus Recovery and Recycling, Springer, Singapore, 2018).

There is therefore a great demand for reaction methods that are capable of overcoming at least one of the above-mentioned drawbacks.

In this context, starting from tetrabutylammonium trimetaphosphate ([nBu₄N]₃[P₃O₉]), Cummins et al. developed a method for synthesizing bis (trichlorosilyl)phosphide as a tetrabutylammonium salt ([nBu₄N][(SiCl₃)₂P]), from which a series of further relevant phosphorus chemicals can be synthesized. For this purpose, tetrabutylammonium trimetaphosphate ([nBu₄N]₃[P₃O₉]) is reacted in a steel reactor in neat trichlorosilane (HSiCl₃; boiling point 32° C.) at 100° C. for 72 h. This produces the salt [nBu₄N][(SiCl₃)₂P] with a 65% yield (see M.B. Geeson, C.C. Cummins, Science, 2018, 359, 1383). The drawbacks of this method are: a) the cation exchange of sodium (Na⁺) to tetrabutylammonium ([nBu₄N]⁺) in order to increase the solubility of [P₃O₉]³⁻, b) the reaction with the pyrophoric, corrosive, and poisonous liquid HSiCl₃ (boiling point 32° C.), which is c) carried out under hydrothermal conditions (100° C.) in a steel reactor, as well as d) the long reaction time of 72 h.

However, this approach offers an alternative option for preparing phosphorus chemicals from metaphosphates [P₃O₉]³⁻ that can be carried out on a laboratory scale. According to Cummins et al., this should provide an incentive for research on alternative methods (see M.B. Geeson, C.C. Cummins, ACS Cent. Sci. 2020, 6, 848).

The present invention solves several of the above-mentioned problems in that a method is provided that makes it possible, starting from phosphate (PO₄³⁻) or phosphoric acid, to obtain by the direct route the desired oxyphosphorus compounds in the oxidation state +V without first changing the oxidation state.

In this method, primary and secondary phosphorous resources based on phosphoric acid or phosphates are directly converted into the corresponding oxyphosphorus compounds while maintaining the oxidation state +V of the phosphorus atom used.

By means of the method of the invention, the synthesis of industrially and academically relevant oxyphosphorus compounds is therefore simplified and shortened in a targeted manner. This saves time, energy, and costs, and reduces the use of chemical waste and hazardous reagents (such as Cl₂ or HSiCl₃).

The present invention thus makes it possible to provide an atom- and energy-efficient solution for the production of oxyphosphorus compounds in the oxidation state (V) directly from phosphoric acid or phosphates.

A central component of the present invention is the synthesis of nitrogenous phosphorus(V) precursors, which can also be referred to as intermediates. These precursors can be reacted with suitable nucleophiles to obtain the desired oxyphosphorus compounds, such as organophosphates (phosphoric acid esters) and phosphinates.

These nitrogenous phosphorus(V) precursors are already known, but the synthesis thereof does not meet the requirements set forth here (see P. Rovnaník, L. Kapička, J. Taraba, M. Černík, Inorg. Chem. 2004, 43, 2435). Other methods of synthesizing oxyphosphorus compounds starting from phosphoric acid or phosphates are already known but also fail to meet the requirements set forth here (A. Sakakura, M. Katsukawa, K. Ishihara, Angew. Chemie Int. Ed. 2007, 46, 1423; A. Sakakura, M. Katsukawa, T. Hayashi, K. Ishihara, Green Chem. 2007, 9, 1166; S. Mohamady, S.D. Taylor, Org. Lett. 2016, 18, 580; S. M. Shepard, C.C. Cummins, ChemRxiv, 2021, DOI: 10.33774/chemrxiv-2021-8v8nx, (not peer reviewed)).

Accordingly, in a first aspect, the present invention relates to a method for synthesizing nitrogenous phosphorus(V) precursors of Formula (I),

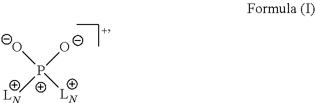

wherein the method comprises the following steps in the order indicated:
a) preparing a phosphate compound;
b) reacting the phosphate compound of step a) with an oxygen acceptor in the
presence of a Lewis base L_{N} that is capable of coordination via a nitrogen atom, wherein the oxygen acceptor is the cation of a sulfonic acid anhydride of Formula (II) and the sulfonic acid anhydride is according to Formula (III),

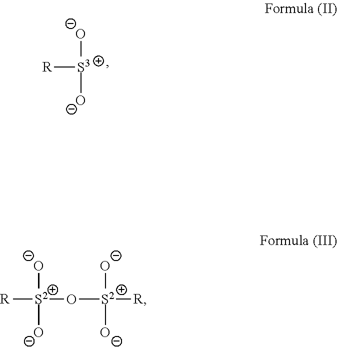

wherein, according to step b), alternatively either
b1) the phosphate compound of step a) is reacted with a sulfonic acid anhydride of Formula (III) in the presence of a Lewis base L_{N}, or
b2) the phosphate compound of step a) is reacted with the reaction product of a sulfonic acid anhydride of Formula (III) with a Lewis base L_{N}, with the above-mentioned reaction product being according to Formula (IV)

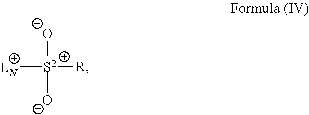

wherein R is an aliphatic or aromatic hydrocarbon radical that can comprise heteroatoms, wherein the number of carbon atoms of the radical R is 1 to 21, and the heteroatoms are selected from the group consisting of oxygen, nitrogen, fluorine, chlorine, bromine, iodine, and mixtures thereof,
wherein the Lewis base L_{N} that is capable of coordination via a nitrogen atom is a nitrogenous heteroaromatic compound, which comprises a six-membered heteroaromatic ring comprising a nitrogen atom capable of coordination, and wherein the number of carbon atoms of the Lewis base L_{N} is from 4 to 19.

The oxygen acceptor of Formula (II) that is active in the method for synthesizing nitrogenous phosphorus(V) precursors of Formula (I) according to step b) is thus either used in the form of the sulfonic acid anhydride of Formula (III) or is alternatively used in the form of the reaction product of Formula (IV), previously prepared by reacting a sulfonic acid anhydride of Formula (III) with a Lewis base L_{N}. In both cases, the active oxygen acceptor of Formula (II) is released in situ during the reaction according to step b) and reacts with the phosphate compound of step a) in the presence of a Lewis base L_{N}.

The resulting nitrogenous phosphorus(V) precursor of Formula (I) is a positively charged monatomic ion, a cation, and can be isolated with a suitable counterion.

The method for synthesizing nitrogenous phosphorus(V) precursors of Formula (I) according to the first aspect of the present invention can thus be described by means of the following general reaction equation:

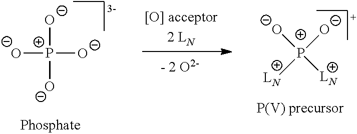

In the reaction equation shown, the phosphate is orthophosphate. A phosphorus atom is deoxygenated twice, which means that formally, one oxygen ion (O²⁻) per phosphorus atom is eliminated twice and taken up by the oxygen acceptor. The two free coordination sites on the phosphorus atom are occupied by two equivalents of the Lewis base L_{N} to form the nitrogenous phosphorus(V) precursor of Formula (I). The coordination of the Lewis base L_{N} takes place via the free electron pair of a nitrogen atom with the formation of two phosphorus-nitrogen-bonds.

If the reaction is carried out not with orthophosphate (corresponding to hydrogen phosphate, dihydrogen phosphate, or phosphoric acid), but with polyphosphates or metaphosphates, or with the further condensed phosphates derivable therefrom, which also comprise chain branches, to obtain polymeric phosphorus pentoxide (P₂O₅)ₓ as a formal end product of the condensation (see Formula A; A.F. Holleman, E. Wiberg, Textbook of Inorganic Chemistry, W.d. Gruyter, Berlin, 102^{nd} edition, 2007), or with phosphorus pentoxide (P₄O₁₀) (see Formula B), the stoichiometry of the oxygen acceptor must be adapted accordingly, as the O/P ratio of 4 in orthophosphate drops to 2.5 with increasing condensation via the poly- and metaphosphates to the polymeric phosphorus pentoxide (P₂O₅)ₓ. Accordingly, in the case of phosphorus pentoxide (P₄O₁₀) as well, the O/P ratio is also 2.5.

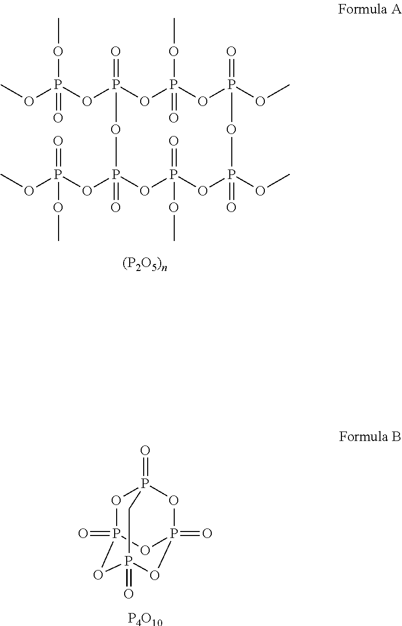

The term “phosphate” is used in the description of the invention and the claims as a collective term describing all compounds comprising at least one phosphorus atom in the oxidation state +V that is covalently bonded to four oxygen atoms, wherein the compound is charged and consists only of phosphorus atoms and oxygen atoms. Phosphate esters and phosphorus pentoxide (P₄O₁₀) are thus not covered by the term “phosphate” according to the present invention.

The term “phosphate” thus includes, inter alia, orthophosphate (PO₄³⁻), oligophosphates and polyphosphates (hereinafter: polyphosphates) such as diphosphate (P₂O₇⁴⁻), triphosphate (P₃O₁₀⁵⁻), etc., the metaphosphates such as trimetaphosphate (P₃O₉³⁻) and tetrametaphosphate (P₄O₁₂⁴⁻), etc., as well as the above-mentioned further condensed phosphates.

The person skilled in the art knows that phosphates are charged species and therefore cannot be used as reactants, but phosphate salts and acids obtainable by (partial) protonation can.

In the description of the invention and in the claims, therefore, the term “phosphate compound” is used. This term describes all of the salts and acids obtainable by (partial) protonation of the phosphates falling under the above-defined collective term “phosphate,” but also phosphorus pentoxide (P₄O₁₀).

Accordingly, the salt of a fully deprotonated phosphate, such as orthophosphate, is understood here as a salt, the acids obtainable by partial protonation, such as hydrogen phosphate and dihydrogen phosphate, are understood as acids, but also as a salt, as these acids are charged, and the acids obtainable by complete protonation, such as phosphoric acid, are understood only as acids.

Accordingly, as reactants for the synthesis of nitrogenous phosphorus(V) precursors according to the first aspect of the present invention, various resources that contain orthophosphate are suitable as phosphate compounds, such as apatite, struvite ((NH₄)Mg(PO₄)·6H₂O), iron phosphate (FePO₄) or lithium iron phosphate (LiFePO₄), as well as chemicals such as phosphoric acid (H₃PO₄), sodium phosphate (Na₃PO₄), potassium phosphate (K₃PO₄), or phosphorus pentoxide (P₄O₁₀).

In addition to mineral deposits, struvite is generated during waste water treatment and liquid manure processing. Lithium iron phosphate is used as a cathode material in lithium iron phosphate batteries. Iron phosphate can also be recovered from battery manufacturing. By providing the possibility of including the use of these secondary phosphorus resources, the invention can also contribute toward protecting primary phosphorus resources.

In addition to orthophosphates and phosphoric acid, condensates can also be used as reactants, such as polyphosphate acids and salts (e.g. diphosphate, triphosphate, etc.) and metaphosphate acids and salts (e.g. trimetaphosphate and tetrametaphosphate, etc.), e.g. sodium trimetaphosphate (Na₃P₃O₉). Only adjustment of the stoichiometry is required.

The phosphate compound is thus selected from the group consisting of orthophosphate salts and acids (PO₄³⁻), polyphosphate salts and acids (PₘO₃ₘ₊₁^{(m+2)-}), metaphosphate salts and acids ((PO₃⁻)ₙ), salts and acids of the above-mentioned further condensed phosphates, phosphorus pentoxide (P₄O₁₀), and mixtures thereof.

Preferred counterions of the above-mentioned salts are selected from the group consisting of the ammonium ion and the monovalent cations of lithium, sodium, potassium, the divalent cations of magnesium, calcium and iron, the trivalent cation of iron, and mixtures thereof. The salts may also comprise hydroxide ions, fluoride ions and/or chloride ions.

Furthermore, it is preferable for the following to apply: m=2 to 10 000, more preferably m=2 to 5000, more preferably m=2 to 3000, more preferably m=2 to 1000, more preferably m=2 to 50.

It is also preferable for the following to apply: n=3 to 10, more preferably n=3 to 7, more preferably n=3 to 5, more preferably n=3 or 4.

In the group of the orthophosphate salts and acids, phosphoric acid (H₃PO₄), apatite (Ca₅(PO₄)₃(F, OH, Cl)), struvite ((NH₄)Mg(PO₄)·6H₂O), iron phosphate (FePO₄), lithium iron phosphate (LiFePO₄), sodium phosphate (Na₃PO₄), potassium phosphate (K₃PO₄), ammonium phosphate ((NH₄)₃PO₄), sodium hydrogen phosphate (Na₂HPO₄), sodium dihydrogen phosphate (NaH₂PO₄), potassium hydrogen phosphate (K₂HPO₄), potassium dihydrogen phosphate (NaH₂PO₄), ammonium hydrogen phosphate ((NH₄)₂HPO₄), and ammonium dihydrogen phosphate (NH₄H₂PO₄) are particularly preferred.

In the group of the polyphosphate salts and acids, sodium polyphosphates, potassium polyphosphates, magnesium polyphosphates and calcium polyphosphates are particularly preferred.

In the group of the metaphosphate salts and acids, metaphosphates and potassium metaphosphates such as sodium trimetaphosphate (Na₃P₃O₉) are particularly preferred.

The most preferable phosphate compound according to the present invention is phosphoric acid (H₃PO₄).

As defined above, the phosphorus atom of the orthophosphate is deoxygenated twice, and the two free coordination sites on the phosphorus atom are occupied by two equivalents of the Lewis base L_{N} to form the nitrogenous phosphorus(V) precursor of Formula (I). It follows that the phosphate compound (here: orthophosphate salts and acids) must be reacted with at least two equivalents of a sulfonic acid anhydride of Formula (III) in the presence of at least two equivalents of a Lewis base L_{N}, or alternatively, the phosphate compound must be reacted with at least two equivalents of the reaction product of Formula (IV).

Here, the respective equivalents are based on the equivalent amount of phosphorus atoms in the phosphate compound. The amount of substance of the reaction partners must of course be adapted to the amount of phosphorus atoms of the phosphate compound.

If the phosphate compound is based on a phosphate that is formally or actually obtainable by condensation of orthophosphate, such as for example the polyphosphates, the metaphosphates, or the above-mentioned further condensed phosphates, or if the phosphate compound is phosphorus pentoxide, the stoichiometry of the oxygen acceptor must be adjusted accordingly.

The sulfonic acid anhydride is ordinarily added in at least ½ equivalent and at most ten equivalents.

The Lewis base L_{N} is ordinarily added in an amount of at least two equivalents and at most ten equivalents. When a solvent is used that corresponds to the definition of a Lewis base L_{N}, with no additional Lewis base L_{N} being used, the equivalent amount of the Lewis base L_{N} is of course greater, ordinarily at most 100 equivalents.

In the alternative variant, the reaction product of Formula (IV) is ordinarily added in an amount of at least two equivalents and at most ten equivalents.

As mentioned above, the radical R of the sulfonic acid anhydride of Formula (III) (and accordingly the radical R in Formulas (II) and (IV)) is an aliphatic or aromatic hydrocarbon radical that can comprise heteroatoms, wherein the number of carbon atoms is from 1 to 21, and the heteroatoms—if present—are selected from the group consisting of oxygen, nitrogen, fluorine, chlorine, bromine, iodine, and mixtures thereof. Other than these specified heteroatoms, the radical R comprises no further heteroatoms.

Preferably, the heteroatoms—if present—are selected from the group consisting of oxygen, nitrogen, fluorine, chlorine, bromine, and iodine, which means that the radical R does not comprise heteroatoms of different atomic numbers.

Preferably, the number of heteroatoms in the radical R is not greater than three.

In the event that R is an aliphatic hydrocarbon radical, the number of carbon atoms is preferably from 1 to 11, more preferably from 1 to 6. Regardless of this, it is preferable for heteroatoms—if present—to be selected from the group consisting of oxygen, nitrogen and fluorine, and mixtures thereof, and particularly preferable for heteroatoms—if present—to be selected from the group consisting of oxygen, nitrogen and fluorine, which means that the radical R does not comprise heteroatoms of different atomic numbers. In this context, it is particularly preferable for the radical R to be selected from the group consisting of C₁-C₆ alkyl, cyclohexyl, C₁-C₆-alkoxy, trifluoromethoxy, trifluoromethyl, C₂F₅, C₂F₄H, C₃F₇, C₃F₆H, C₄F₉, C₄F₈H, C₅F₁₁ and C₅F₁₀H. The most preferable aliphatic hydrocarbon radical R in this connection is trifluoromethyl (CF₃).

In the event that R is an aromatic hydrocarbon radical, R is preferably defined by the following Formula (IIIa):

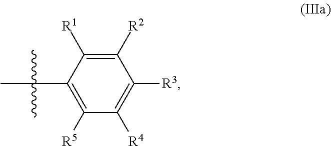

wherein the radicals R¹, R², R³, R⁴, and R⁵ are selected independently from one another from the group consisting of hydrogen, C₁-C₃ alkyl, C₁-C₃ alkoxy, fluorine, chlorine, bromine, iodine, the nitro group, and trifluoromethyl. In this context, it is particularly preferable for the radicals R¹, R², R³, R⁴, and R⁵ to be selected independently from one another from the group consisting of hydrogen, methyl, methoxy, fluorine, chlorine, the nitro group, and trifluoromethyl. In this preferred group, the radicals R¹, R², R³, R⁴, and R⁵ are more preferably selected from the following combinations:
R¹, R², R³, R⁴, R⁵=H,
R¹, R², R³, R⁴, R⁵=CH₃,
R¹, R², R³, R⁴=H and R⁵=CH₃,
R¹, R², R³, R⁴=H and R⁵=F,
R¹, R², R³, R⁴=H and R⁵=Cl,
R¹, R², R³, R⁴=H and R⁵=OCH₃,
R¹, R², R³, R⁴=H and R⁵=NO₂,
R¹, R², R³, R⁴=H and R⁵=CF₃,
R¹, R², R⁴=H and R³, R⁵=CH₃,
R², R⁴=H and R¹, R³, R⁵=CH₃,
R², R³, R⁵=H and R¹, R⁴=CH₃, or
R¹, R², R⁴, R⁵=H and R³=CH₃.

The most preferable combination in this context is:
R¹, R², R⁴, R⁵=H and R³=CH₃.

The most preferable sulfonic acid anhydride of Formula (III) with an aliphatic hydrocarbon radical R is thus trifluoromethanesulfonic anhydride (Tf₂O), and accordingly, the most preferable cation of a sulfonic acid anhydride of Formula (II) with an aliphatic hydrocarbon radical R is the triflyl cation F₃CSO₂⁺ (Tf⁺).

The most preferable sulfonic acid anhydride of Formula (III) with an aromatic hydrocarbon radical R is thus p-toluenesulfonic anhydride, and accordingly, the most preferable cation of a sulfonic acid anhydride of Formula (II) with an aromatic hydrocarbon radical R is the tosyl cation H₃C—C₆H₄—SO₂⁺ (Ts⁺).

The most preferable sulfonic acid anhydride of Formula (III) is trifluoromethanesulfonic anhydride (Tf₂O), and accordingly, the most preferable cation of a sulfonic acid anhydride of Formula (II) is the triflyl cation F₃CSO₂⁺ (Tf⁺).

In the most preferable method according to the first aspect of the present invention, two equivalents of the triflyl cation thus deoxygenate a phosphorus atom of the phosphate compound twice, forming two equivalents of trifluoromethane sulfonate (triflate, OTf⁻).

The triflyl cation is therefore the most preferable oxygen acceptor in the method according to the first aspect of the present invention.

The triflyl cation can be used in the method in the form of trifluoromethanesulfonic anhydride.

Alternatively to the use of trifluoromethanesulfonic anhydride, trifluoromethanesulfonic anhydride, Tf₂O, can be reacted with the Lewis base L_{N} in advance. The reaction product comprises the triflyl cation bound to the Lewis base L_{N} as a salt of the triflate anion, OTf⁻:

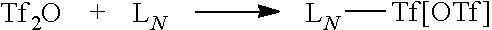

The reaction scheme of the particularly preferred embodiment using trifluoromethanesulfonic anhydride is shown below:

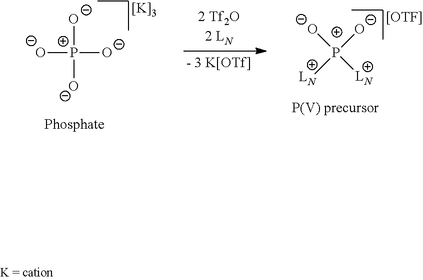

The reaction scheme of the alternative particularly preferred embodiment using [L_{N}-Tf][OTf] is shown below:

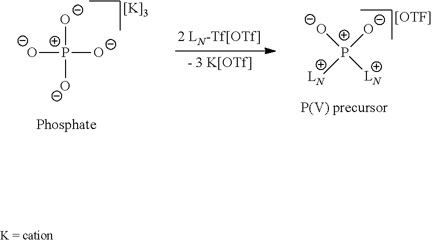

As mentioned above, the Lewis base L_{N} is capable of coordination via a nitrogen atom and is a nitrogenous heteroaromatic compound, which comprises one, i.e. at least one six-membered heteroaromatic ring comprising one, i.e. at least one nitrogen atom that is capable of coordination, and wherein the number of carbon atoms of the Lewis base L_{N} is 4 to 19.

The Lewis base L_{N} can further comprise heteroatoms selected from the list consisting of nitrogen, oxygen, sulfur, fluorine, chlorine, bromine, iodine, and mixtures thereof. Other than the above-mentioned heteroatoms, the Lewis base L_{N} comprises no further heteroatoms.

The Lewis base L_{N} preferably comprises one or two of the above-mentioned six-membered heteroaromatic rings.

The Lewis base L_{N} preferably comprises one or two nitrogen atoms.

Preferably, the Lewis base L_{N} comprises one or two six-membered heteroaromatic rings, the Lewis base L_{N} comprises one or two nitrogen atoms capable of coordination per six-membered heteroaromatic ring in the six-membered heteroaromatic ring, and the Lewis base L_{N} comprises a total of one or two nitrogen atoms.

The Lewis base L_{N} preferably comprises—if oxygen atoms are present—one or two oxygen atoms.

The oxygen atoms of the Lewis base L_{N} are—if present—more preferably part of methoxy or ethoxy groups.

The Lewis base L_{N} preferably comprises not more than two methoxy or ethoxy groups.

The Lewis base L_{N} preferably comprises—if these heteroatoms are present—one, two, three or four heteroatoms selected from the group consisting of fluorine, chlorine, bromine, iodine, and mixtures thereof.

The Lewis base L_{N} preferably comprises—if these heteroatoms are present—one, two, three or four heteroatoms selected from the group consisting of fluorine, chlorine, bromine, iodine, which means that the Lewis base L_{N} does not comprise heteroatoms of this group with different atomic numbers.

The Lewis base L_{N} preferably comprises no sulfur.

The Lewis base L_{N} particularly preferably comprises, independently of each other, one or two nitrogen atoms, zero, one or two oxygen atoms, zero, one, two, three or four heteroatoms selected from the group consisting of fluorine, chlorine, bromine, and iodine, and does not comprise any further heteroatoms.

The Lewis base L_{N} is preferably selected from the group consisting of pyridines, picolines, lutidines, collidines, bipyridines, pyridazines, pyrimidines, pyrazines, quinolines and isoquinolines.

The Lewis base L_{N} is more preferably selected from the following substances or substance classes:
Pyridine, mono- or polymethyl-substituted pyridines such as pentamethylpyridine, picolines, lutidines, and collidines, mono-alkyl-substituted pyridines, wherein the alkyl radical comprise between 2 and 10 carbon atoms, mono-phenyl-substituted pyridines, aminopyridines, dimethylaminopyridines, mono- or dimethoxy- or ethoxy-substituted pyridines, as well as mono-, di-, or tri-halogen-substituted pyridines.

Bipyridine, mono-methyl-substituted bipyridines, mono-halogen-substituted bipyridines, di-methyl-substituted bipyridines, di-halogen-substituted bipyridines, tetra-methyl-substituted bipyridines, as well as tetra-halogen-substituted bipyridines.

Diazines such as pyridazine, pyrimidine and pyrazine, mono-methyl-substituted pyridazines, mono-halogen-substituted pyridazines, di-methyl-substituted pyridazines, di-halogen-substituted pyridazines, tri-methyl-substituted pyridazines, tri-halogen-substituted pyridazines, tetra-methyl-substituted pyridazine, tetra-halogen-substituted pyridazine, mono-methyl-substituted pyrimidines, mono-halogen-substituted pyrimidines, di-methyl-substituted pyrimidines, di-halogen-substituted pyrimidines, tri-methyl-substituted pyrimidines, tri-halogen-substituted pyrimidines, tetra-methyl-substituted pyrimidine, tetra-halogen-substituted pyrimidine, mono-methyl-substituted pyrazines, mono-halogen-substituted pyrazines, di-methyl-substituted pyrazines, di-halogen-substituted pyrazines, tri-methyl-substituted pyrazines, tri-halogen-substituted pyrazines, tetra-methyl-substituted pyrazine, as well as tetra-halogen-substituted pyrazine.

Quinolines such as quinoline, mono-methyl-substituted quinolines, di-methyl-substituted quinolines, tri-methyl-substituted quinolines, tetra-methyl-substituted quinolines, mono-halogen-substituted quinolines, wherein substitution with one to six methyl groups may be present at the same time, as well as hepta-methyl-substituted quinoline.

Isoquinolines such as isoquinoline, mono-methyl-substituted isoquinolines, di-methyl-substituted isoquinolines, mono-halogen-substituted isoquinolines, wherein substitution with one to six methyl groups may be present at the same time, as well as hepta-methyl-substituted isoquinoline.

The number of carbon atoms of the Lewis base L_{N} is preferably from 4 to 16, more preferably from 4 to 12, and particularly preferably from 5 to 9.

The Lewis base L_{N} more preferably comprises one or two nitrogen atoms and no further heteroatoms.

According to a particularly preferred embodiment of the present invention, the Lewis base L_{N} is selected from the group consisting of pyridine, 4-dimethylaminopyridine, and mixtures thereof.

Moreover, the Lewis base L_{N} can only form during the reaction if, as described above, the Lewis base L_{N} is reacted with a sulfonic acid anhydride, such as, most preferably, trifluoromethanesulfonic anhydride, Tf₂O, before carrying out the method according to the first aspect of the present invention. The reaction product in this alternative is [L_{N}-Tf][OTf], which is then used in the method according to the first aspect of the present invention. As soon as the oxygen acceptor, the triflyl cation, Tf⁺, reacts to form the triflate anion, OTf⁻, L_{N} is released and can bind to the phosphorus atom of the phosphate compound. Thus in this alternative as well, reaction of the phosphate compound with the oxygen acceptor takes place in the presence of a Lewis base L_{N}.

The method according to the first aspect of the present invention can be carried out in solution, in the melt, or as solid reaction.

In the method according to the first aspect of the present invention, the synthesis particularly preferably takes place in an aprotic solvent.

Furthermore, it is particularly preferred that in the method according to the first aspect of the present invention, no further Lewis bases or nucleophiles other than the Lewis base L_{N} are added. Here, further Lewis bases or nucleophiles are understood to be substances that are different from the above-defined Lewis base L_{N}. These further Lewis bases or nucleophiles could compete with the above-defined Lewis base L_{N} for bonding to the phosphorus atom of the phosphate compound and thus make formation of the nitrogenous phosphorus(V) precursor of Formula (I) more difficult, prevent it, or reduce the yield thereof by forming mixtures.

In this connection, the person skilled in the art is aware, from similar reactions of the prior art, of the need to exclude further Lewis bases or nucleophiles from the reaction. In particular, the person skilled in the art will for example exclude the following substances from the reaction: water, alcohols, ammonia, amines, imines, azoles, pyrrolines, sulfides, halides, and organometallic reagents.

Further preferably, the solvent is defined as the Lewis base L_{N}, wherein it is also the case for the solvent that its melting point is below 20° C. is (at normal pressure corresponding to 101325 Pa).

Pyridine is particularly preferable as a solvent.

In the case of a solid reaction, the reaction is preferably carried out at elevated temperature, preferably above 100° C. The temperature will usually be below 200° C.

According to a particularly preferred embodiment of the method according to the first aspect of the present invention, the phosphate compound is selected from the group consisting of orthophosphate salts and acids and mixtures thereof, the sulfonic acid anhydride of Formula (III) is trifluoromethanesulfonic anhydride, and the Lewis base L_{N} is selected from the group consisting of pyridine, 4-dimethylaminopyridine, and mixtures thereof.

According to a further particularly preferred embodiment of the method according to the first aspect of the present invention, the phosphate compound is phosphoric acid (H₃PO₄), the sulfonic acid anhydride of Formula (III) is trifluoromethanesulfonic anhydride, and the Lewis base L_{N} is selected from the group consisting of pyridine, 4-dimethylaminopyridine, and mixtures thereof.

According to a further particularly preferred embodiment of the method according to the first aspect of the present invention, the phosphate compound is phosphoric acid (H₃PO₄), the sulfonic acid anhydride of Formula (III) is trifluoromethanesulfonic anhydride, the Lewis base L_{N} is pyridine or 4-dimethylaminopyridine, and the synthesis is carried out in pyridine as a solvent.

When pyridine is used as the most preferable solvent in the method according to the first aspect of the present invention, it also automatically acts as a Lewis base L_{N}. However, if the method is carried out with pyridine as a solvent in the presence of 4-dimethylaminopyridine as a Lewis base L_{N}, the nitrogenous phosphorus(V) precursor of Formula (I) comprises two equivalents of 4-dimethylaminopyridine.

In use of trifluoromethanesulfonic anhydride as the sulfonic acid anhydride of Formula (III), pyridine or 4-dimethylaminopyridine as the Lewis base L_{N}, and pyridine as a solvent, the cation of Formula (I) precipitates with triflate, OTf⁻, as a counterion from the solution and can be isolated and washed in the usual manner.

In a second aspect, the present invention relates to a method for synthesizing oxyphosphorus compounds, wherein the method comprises the following steps in the order indicated:
c) synthesis of a nitrogenous phosphorus(V) precursor of Formula (I) according to the first aspect of the present invention;

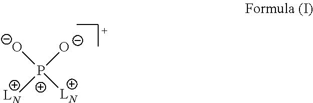

d) reacting the nitrogenous phosphorus(V) precursor of Formula (I) with a nucleophile.

The person skilled in the art knows the term nucleophile. In the method according to the second aspect of the present invention, any desired nucleophile may be used.

The nucleophile is preferably selected from the group consisting of alcohols, ammonia, primary amines, secondary amines, tertiary amines, azoles, organometallic compounds and fluoride. Fluoride can be used in the usual manner as a metal fluoride such as cesium fluoride. In addition, any of the compounds described above in connection with the first aspect of the present invention as a Lewis base L_{N} can be used as a nucleophile.

The person skilled in the art knows that in such reactions of a nucleophile, the nucleophile can if necessary also be used in the deprotonated variant. In the case of the alcohols, these are the alcoholates, which can be used in the usual manner as metal alcoholates.

With respect to suitable and preferred compounds that can be used as the phosphate compound, the sulfonic acid anhydride of Formula (III), the Lewis base L_{N}, and a solvent in step c) above of the method according to the second aspect of the present invention, reference is made to the corresponding statements in connection with the first aspect of the present invention. The same applies for suitable and preferred reaction conditions.

The nitrogenous phosphorus(V) precursor of Formula (I) according to the first aspect of the present invention can be isolated and then used in step d) of the method according to the second aspect of the present invention.

Step d) of the method according to the second aspect of the present invention preferably takes place in solution or in a suspension of the reaction partners in a non-aqueous solvent. Suitable nucleophiles can also be used as solvents. Typical solvents are all common organic solvents (e.g. acetonitrile, nitromethane, tetrahydrofuran, pyridine, dichloromethane) and mixtures thereof. The person skilled in the art is aware of which further solvents can in principle be used and will be able to determine a suitable solvent for each reaction pair consisting of the nitrogenous phosphorus(V) precursor of Formula (I) and a nucleophile. Finding a suitable solvent is part of the basic technical knowledge of a person skilled in the art in the field of preparative chemistry.

An example of a nucleophile that can be used as a solvent is e.g. 2-ethylhexanol.

Alternatively, in order to isolate the nitrogenous phosphorus(V) precursor of Formula (I) according to the first aspect of the present invention, the nucleophile according to step d) of the method according to the second aspect of the present invention can also be added to the reaction mixture of step b) of the method according to the first aspect of the present invention.

In this case, the two reactions take place in one and the same reaction vessel. However, one must wait until the synthesis of the nitrogenous phosphorus(V) precursor of Formula (I) is completed, i.e. until the reaction has reached equilibrium or is no longer changing. The person skilled in the art knows how to determine this point in time by means of suitable analysis, such as NMR spectroscopy of the reaction solution.

In the case of a particularly preferred embodiment of the method according to the first aspect of the present invention, the reaction is carried out in pyridine as a solvent, the sulfonic acid anhydride of Formula (III) is trifluoromethanesulfonic anhydride, and the Lewis base L_{N} is either the solvent pyridine, or in addition, 4-dimethylaminopyridine is added as the Lewis base L_{N}. In this particularly preferred embodiment, the product, the salt from the cation of Formula (I) with triflate, OTf⁻, precipitates from the solution as a counterion. The progress of the reaction can thus be determined by the cloudiness of the solution. In a so-called one-pot reaction, the nucleophile can be added to this suspension.

Depending on whether or not the nucleophile is deprotonated before or during the reaction, the resulting product can be an anion or a cation, which can be isolated from the reaction solution with a suitable counterion and purified in the usual manner.

If the nucleophile is an alcohol or an alcoholate, the reaction according to the second aspect of the present invention can be illustrated as follows:

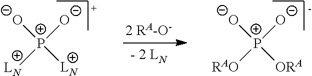

In this manner, the corresponding diesters of the phosphoric acid are mono-accessible. In contrast to classical synthesis from phosphorus pentoxide and alcohol, the diesters are produced selectively, which obviates the need for separation of the monoesters and triesters from a product mixture. In principle, any alcohol or any alcoholate is suitable as a nucleophile.

The radical R^{A} is a hydrocarbon radical that can comprise heteroatoms. Two radicals R^{A} can together form a bridge between two hydroxyl groups, and the alcohol can thus bind to the phosphorus atom as a bridging chelating ligand.

Preferably, the number of carbon atoms of R^{A} is between 1 and 50 or between 1 and 25. Further preferably, the heteroatoms are selected from the group consisting of nitrogen, oxygen, sulfur, fluorine, chlorine, and bromine. Particularly preferably, the radical R^{A} comprises no further heteroatoms other than oxygen, nitrogen and fluorine, and more preferably no further heteroatoms.

In addition to monohydric alcohols, suitable alcohols include diols, polyols, sugar alcohols and sugar, including nucleosides.

For example, 2-ethylhexanol can be used as a nucleophile. The reaction with two equivalents of 2-ethylhexanol provides industrially important bis(2-ethylhexyl)phosphate in a simple manner (see data sheet bis(2-ethylhexyl) phosphate, 95% at AlfaAesar, accessed on 25 Mar. 2020 (PDF)). Equally industrially important is the use of 2,2,2-trifluorethanol as a nucleophile for the analogous synthesis of bis(2,2,2-trifluoroethyl)phosphate (see a) A. Maruo, S. Yamazaki, Liquid electrolyte comprising an alkali metal salt of a phosphate compound, WO-A1-2013/002186; b) A. Garsuch, M. Schmidt, R. Schmitz, I. Krossing, P. Eiden, S., Reininger, Inorganic coordination polymers as gelling agents, WO 2015/128363 A1). Finally, the method according to the present invention allows the simple conversion of 1,1′-bi-2-naphthol (BINOL) to BINOL phosphate (see D. Parmar, E. Sugiono, S. Raja, M. Rueping, Chem. Rev. 2014, 114, 9047).

If the nucleophile is ammonia, the reaction according to the second aspect of the present invention can be illustrated as follows:

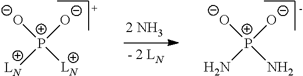

In this manner, diamidophosphate is mono-accessible.

If the nucleophile a is a primary amine, the reaction according to the second aspect of the present invention can be illustrated as follows:

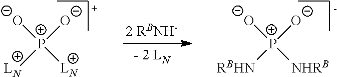

In this manner, diamidophosphate is mono-accessible.

In principle, any primary amine or any primary amide is suitable as a nucleophile.

The radical R^{B} is a hydrocarbon that can comprise heteroatoms. Two radicals R^{B} can together form a bridge between two amine groups, and the amine can thus coordinate to the phosphorus atom as a bridging chelating ligand.

Preferably, the number of carbon atoms of R^{B} is between 1 and 25 or between 1 and 10. Further preferably, the heteroatoms are selected from the group consisting of nitrogen, oxygen, sulfur, fluorine, chlorine, and bromine. Particularly preferably, the radical R^{B} comprises no further heteroatoms other than oxygen, nitrogen and fluorine, and more preferably no further heteroatoms.

If the nucleophile is a secondary amine, the reaction according to the second aspect of the present invention can be illustrated as follows:

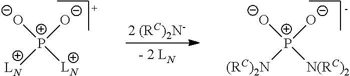

In this manner, the corresponding diamidophosphates are mono-accessible.

In principle, any secondary amine or any secondary amide is suitable as a nucleophile.

The radical R^{C} is a hydrocarbon that can comprise heteroatoms. Two radicals R^{C} can together form a bridge between two amine groups, and the amine can thus coordinate to the phosphorus atom as a bridging chelating ligand.

Preferably, the number of carbon atoms of R^{C} is between 1 and 25 or between 1 and 10. Further preferably, the heteroatoms are selected from the group consisting of nitrogen, oxygen, sulfur, fluorine, chlorine, and bromine. Particularly preferably, the radical R^{C} comprises no further heteroatoms other than oxygen, nitrogen and fluorine, and more preferably no further heteroatoms.

If the nucleophile is a tertiary amine, the reaction according to the second aspect of the present invention can be illustrated as follows:

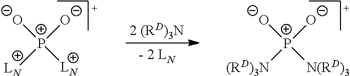

In this manner, the corresponding diamidophosphates are mono-accessible.

In principle, any tertiary amine is suitable as a nucleophile.

The radical R^{D} is a hydrocarbon that can comprise heteroatoms. Two radicals R^{D} can together form a bridge between two amine groups, and the amine can thus coordinate to the phosphorus atom as a bridging chelating ligand.

Preferably, the number of carbon atoms of R^{D} is between 1 and 25 or between 1 and 10. Further preferably, the heteroatoms are selected from the group consisting of nitrogen, oxygen, sulfur, fluorine, chlorine, and bromine. Particularly preferably, the radical R^{D} comprises no further heteroatoms other than oxygen, nitrogen and fluorine, and more preferably no further heteroatoms.

If the nucleophile is an azole, the reaction according to the second aspect of the present invention can be illustrated as follows:

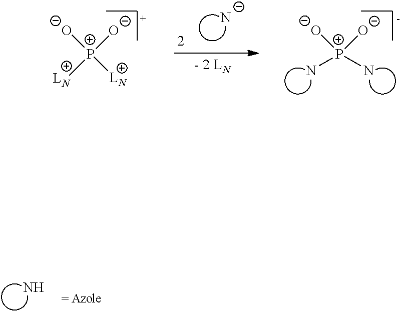

In this manner, the corresponding diamidophosphates are mono-accessible.

The nucleophilic azole is preferably selected from the group consisting of pyrroles, imidazoles, pyrazoles, triazoles and tetrazoles.

Here, the following specific examples can be mentioned:
pyrroles such as pyrrole, mono-alkyl-substituted pyrroles, di-alkyl-substituted pyrroles, tri-alkyl-substituted pyrroles, tetra-alkyl-substituted pyrroles;
imidazoles such as 1,3-imidazoles, mono-alkyl-substituted imidazoles, di-alkyl-substituted imidazoles, tri-alkyl-substituted imidazoles;
pyrazoles such as 1,2-pyrazole, mono-alkyl-substituted pyrazoles, di-alkyl-substituted pyrazoles, tri-alkyl-substituted pyrazoles;
triazoles such as 1,2,3-triazole, 1,2,4-triazole, mono-alkyl-substituted triazoles, di-alkyl-substituted triazoles;
tetrazoles such as tetrazole, mono-alkyl-substituted tetrazoles,

The number of carbon atoms of the azoles is preferably from 4 to 24.

The azoles also preferably comprise one to four nitrogen atoms and no further heteroatoms.

If the nucleophile is an organometallic compound, the reaction according to the second aspect of the present invention can be illustrated as follows:

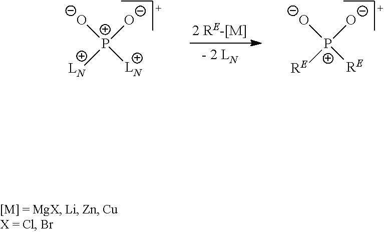

In this manner, the corresponding phosphinates are mono-accessible.

In principle, any organometallic compound in which the carbon atom undergoes a nucleophilic reaction is suitable as a nucleophile. This includes organometallic compounds with metals, for example lithium, magnesium, aluminum, zinc and copper.

The radical R^{E} is a hydrocarbon radical that can comprise heteroatoms. Two radicals R^{E} can together form a bridge between two carbon atoms and thus coordinate to the phosphorus atom as a bridging chelating ligand.

Preferably, the number of carbon atoms of R^{E} is between 1 and 25 or between 1 and 10. Further preferably, the heteroatoms are selected from the group consisting of nitrogen, oxygen, sulfur, fluorine, chlorine, and bromine. Particularly preferably, the radical R^{E} comprises no further heteroatoms, more preferably no further heteroatoms.

### EXPERIMENTAL PART

All reactions were carried out in a dried inert gas atmosphere (N₂ or Ar) using a glove box (Innovative Technology Pure Lab HE, MBraun Unilab) or by means of the Schlenk technique. Before use, glassware was stored at 150° C. or heated under a vacuum using a hot air blower. Microwave reactions were conducted in sealed glass tubes in the CEM Discover reactor. The solvents used were first distilled with suitable desiccants and stored over a molecular sieve. The deuterated solvents CD₂Cl₂, CD₃CN, C₆D₆ and C₇D₈ were obtained from Merck, Deutero or Eurisotop and stored over a molecular sieve before use. Aqueous processing was carried out under normal conditions (no inert gas used). Aqueous solutions (distilled H₂O, saturated NaCl solution) were degassed in advance in an ultrasonic bath.

### ¹H-NMR, ¹³C-NMR, ³¹P-NMR, ¹⁹F-NMR

Nuclear magnetic resonance experiments were carried out on the devices AVANCE III HD Nanobay 400 MHz Ultrashield (resonance frequencies: ¹H=400.13 MHZ, ¹³C=100.61 MHZ, ¹⁹F=376.50 Hz, ³¹P=161.98 MHZ) or AVANCE III HDX 500 MHZ Ascend (resonance frequencies: ¹H=500. 13 MHZ, ¹³C=125.75 MHZ, ¹⁹F=470.59 MHz, ³¹P=202.45 MHZ) from the firm Bruker and evaluated using the software Topspin. The values of the chemical shift δ refer to the external standards tetramethylsilane (¹H, ¹³C), trichlorofluoromethane (¹⁹F) or phosphoric acid 85% (³¹P) and are given in ppm rounded off to 1-2 decimal places. Scalar couplings via n bonds ⁿJ are given in Hz rounded off to 1-2 decimal places. ¹³C-NMR spectra were measured in all cases with ¹H broad band decoupling. For assignment of the signals, if necessary, additional 2D correlation experiments (HSQC, HMBC, HH-COSY, ¹H-³¹P-HMBC) were carried out. In order to describe multiplicity, the following abbreviations are used: s—singlet, s(br)—broad singlet, d—doublet, t—triplet, q—quartet, m—multiplet. Combinations of these abbreviations are given in all cases in decreasing order of coupling constants. Temperature-dependent measurements were recorded using a BCU II temperature unit (120°° C. to −40°° C.) or a nitrogen vaporizer (−50° C. to −100° C.).

### Chemicals

Chemicals and solvents were obtained from Merck, VWR, Alfa Aesar, Acros Organics or TCl. Trifluoromethanesulfonic anhydride (Tf₂O) was donated by the firm Solvay.

Abbreviations

| | |
|---|---|
| BINOL | 1,1′-bi-2-naphthol |
| DMAP | 4-(dimethylamino)pyridine |
| HOTf | trifluoromethanesulfonic acid |
| KOtBu | potassium tert-butanolate |
| MeOH | methanol |
| OTf⁻ | trifluoromethane sulfonate |
| PhMgBr | phenyl magnesium bromide |
| PhOH | phenol |
| Pyr | pyridine |
| Tf⁺ | triflate cation |
| Tf₂O | trifluoromethanesulfonic anhydride |
| THF | tetrahydrofuran |
| 4-Me-Pyr | 4-methylpyridine |

### EXAMPLES

### Example 1: Synthesis of (L_{N})₂PO₂[OTf] (L_{N}=pyrdiniumyl) From H₃PO₄

Pure phosphoric acid (610 mg, 6.22 mmol) is placed in pyridine (8 ml) and cooled to −30° C. Cold (−30° C.) trifluoromethanesulfonic anhydride (Tf₂O; 3.86 g, 13.7 mmol) is slowly added to this dropwise. The reaction solution turns orange/brown, and a colorless, sticky solid forms, which slowly dissolves in the course of the reaction. After 15 min, a colorless precipitate forms. The reaction mixture is then stirred for 12 h at 40° C. The solid is filtered through a glass frit, washed with pyridine (2×6 ml), and then vacuum-dried. The product is obtained as a colorless solid in quantitative yield [2.32 g; (>99%)].

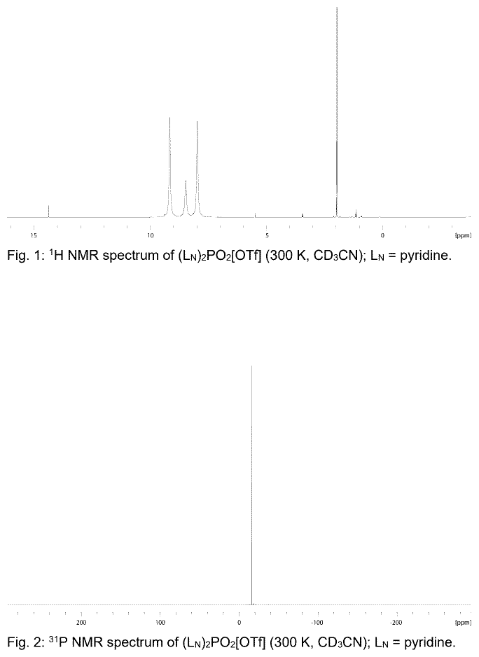

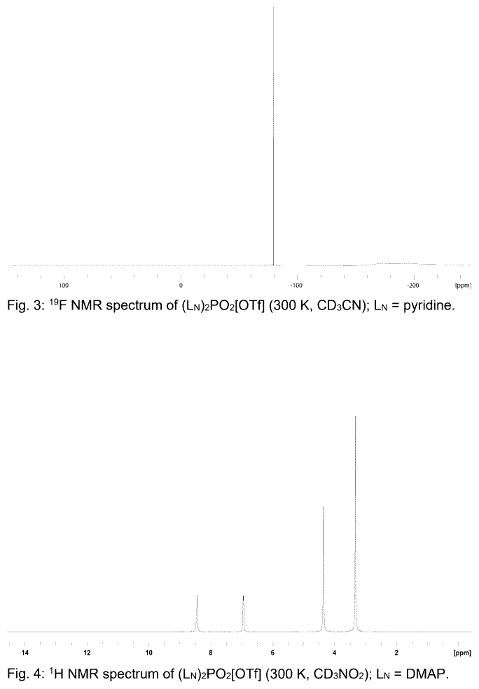

The product is characterized by multinuclear NMR spectroscopy (NMR spectra are attached in the appendix; FIGS. 1-3). The product is soluble in CH₃CN and freely soluble in CH₃NO₂.

¹H NMR (CD₃CN, 300 K, δ in ppm): 7.97 (4H, s(br), H2), 8.48 (2H, s(br), H3), 9.16 (4H, s(br), H1); ¹⁹F NMR (CD₃CN, 300 K, δ in ppm): −79.2 (3F, s, OTf⁻); ³¹P NMR (CD₃CN, 300 K, δ in ppm): −15.8 (1P, s).

### Example 2: Synthesis of (L_{N})₂PO₂[OTf] (L_{N}=pyrdiniumyl) From 85% H₃PO₄

85% phosphoric acid (400 mg; corresponds to 340 mg, 3.5 mmol, H₃PO₄) is prepared and placed in pyridine (5 ml) and cooled to −30° C. Cold (−30° C.) trifluoromethanesulfonic anhydride (Tf₂O; 3.15 g, 11.2 mmol) is slowly added to this dropwise. The reaction solution turns brown and a colorless, sticky solid forms, which slowly dissolves in the course of the reaction. After 15 min, a colorless precipitate forms. The reaction mixture is then stirred for 12 h at 40° C. The solid is filtered through a glass frit, washed with pyridine (2×6 ml), and then vacuum-dried. The product is obtained as a colorless solid in a very good yield [1.09 g; (85%)].

The product is characterized by multinuclear NMR spectroscopy. The product is freely soluble in CH₃CN.

¹H NMR (CD₃CN, 300 K, δ in ppm): 7.97 (4H, s(br), H2), 8.48 (2H, s(br), H3), 9.16 (4H, s(br), H1); ¹⁹F NMR (CD₃CN, 300 K, δ in ppm): −79.2 (3F, s, OTf⁻); ³¹P NMR (CD₃CN, 300 K, δ in ppm): −15.8 (1P, s).

### Example 3: Synthesis of (L_{N})₂PO₂[OTf] (L_{N}=4-dimethylaminopyridiniumyl) From H₃PO₄

Pure phosphoric acid (44 mg, 0.44 mmol) and [DMAP-Tf][OTf] (see S. Yogendra, F. Hennrsdorf, A. Bauzá, A. Frontera, R. Fischer, J.J. Weigand, Chem. Commun. 2017, 53, 2954) (373 mg, 0.92 mmol) are weighed together and pyridine is then added (3 ml). The colorless reaction solution if stirred for 12 h at room temperature, and a colorless precipitate forms during this time. The solid is filtered, washed with CH₂Cl₂ (2×2 ml), and then vacuum-dried. The product is obtained as a colorless solid in 81% yield (163 mg). The product is sparingly soluble in various solvents (CH₂Cl₂, PhF, CH₃CN).

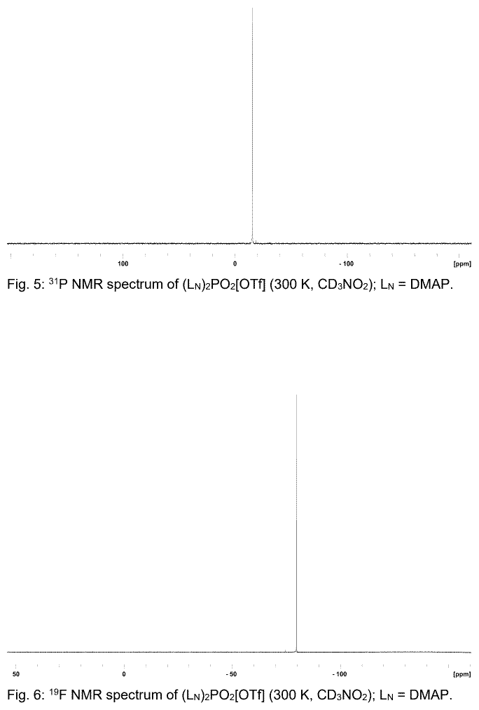

The product is characterized by multinuclear NMR spectroscopy (NMR spectra are attached in the appendix; FIGS. 4-6). The product is soluble in CH₃NO₂.

¹H NMR (MeNO₂, C₆D₆ capillary, 300 K, δ in ppm): 4.55 (12H, s, H4), 8.17 (4H, d(br), ³J_{HH}=6.9 Hz, H2), 9.66 (2H, pseudo t(br), ²J_{HH}=7.0 Hz, H1); ¹⁹F NMR (MeNO₂, C₆D₆ capillary, 300 K, δ in ppm): −78.4 (3F, s, OTf⁻); ³¹P NMR (MeNO₂, C₆D₆ capillary, 300 K, δ in ppm): −14.2 (1P, s).

### Example 4: Synthesis of (L_{N})₂PO₂[OTf] (L_{N}=4-methylpyridiniumyl) From H₃PO₄

Pure phosphoric acid (133 mg, 1.35 mmol) is prepared and placed in pyridine (6 ml) and cooled to −30° C. Cold (−30° C.) trifluoromethanesulfonic anhydride (Tf₂O; 817 mg, 2.9 mmol) is slowly added to this dropwise. The reaction solution turns orange/brown, and a colorless, sticky solid forms, which slowly dissolves in the course of the reaction. After 15 min, a colorless precipitate forms. The reaction mixture is then stirred for 12 h at 40° C. After this, 4-methylpyridine (377 mg, 4.05 mmol) is added, whereupon the cloudy reaction mixture slowly becomes clear. After 2 h, a solid precipitates, which is filtered, washed with n-pentane (4 ml), and dried in a vacuum to isolate it as a colorless powder. Yield [487 mg; (>91%)].

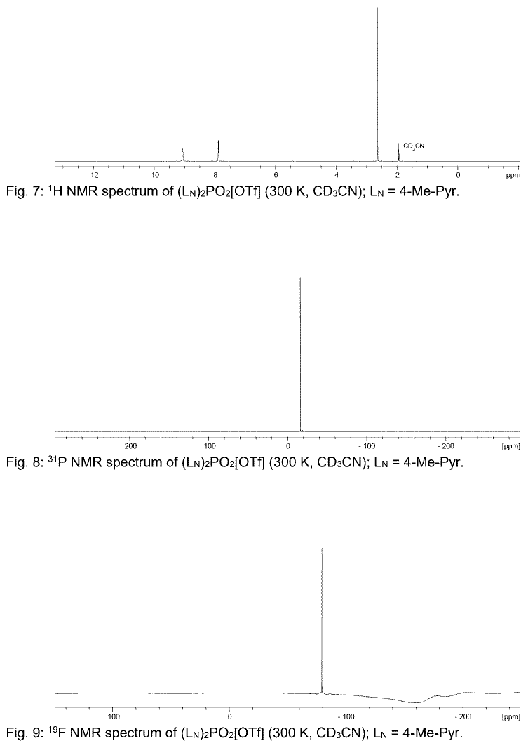

The product is characterized by multinuclear NMR spectroscopy (NMR spectra are attached in the appendix; FIGS. 7-9). The product is soluble in CH₃CN.

¹H NMR (CD₃CN, 300 K, δ in ppm): 2.63 (6H, s, H4), 7.88 (4H, d, ³J_{HH}=6.3 Hz, H2), 9.06 (4H, m, H1); ¹³C{¹H} NMR (CD₃CN, δ in ppm): 22.7 (s, 2C, C4), 122.1 (q, 1C, ¹J_{CF}=320.9 Hz, OTf⁻), 129.7 (s, 4C, C2), 145.2 (s, 4C, C1), 165.7 (s, 2C, C3); ¹⁹F NMR (CD₃CN, δ in ppm): −79.3 (s, 3F, OTf⁻); ³¹P NMR (CD₃CN, δ in ppm): −16.0 (s, 1P).

### Example 5: Reactions of Potassium Phosphate (K₃[PO₄])

### Example 5a): Reaction at Elevated Temperature

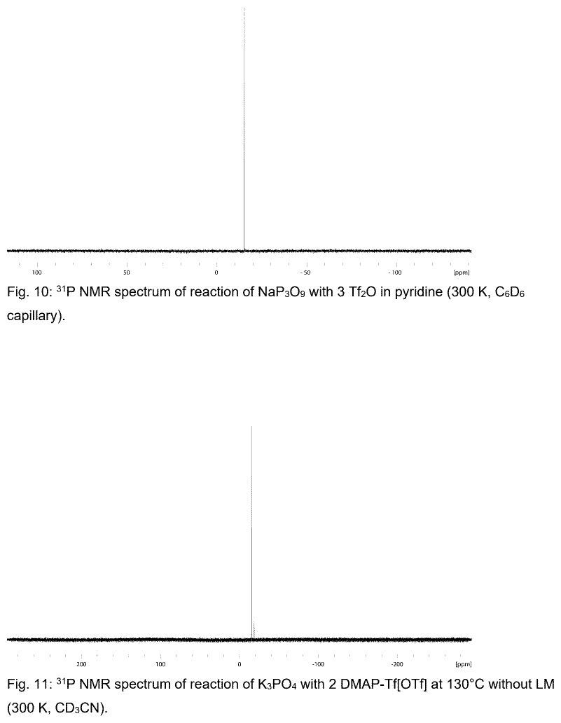

Potassium phosphate (106 mg, 0.5 mmol) and [DMAP-Tf][OTf] (404 mg, 1.0 mmol) are weighed together and heated while stirring to 130° C. The initially colorless substance mixture takes on a beige color after approx. 90 min and becomes slightly pasty. Samples are taken from this mixture and examined by multinuclear NMR spectroscopy. The formation of [(DMAP)₂PO₂]⁺ is observed after only 3 h in the ³¹P NMR spectrum (³¹P NMR (CD₃CN, 300 K, δ in ppm): −15.8 (1P, s); ³¹P NMR spectrum is attached in the appendix; FIG. 10).

### Example 5b): Reaction Under Mechanical/Chemical Conditions

Potassium phosphate (50 mg, 0.236 mmol) and [DMAP-Tf][OTf] (190 mg, 0.471 mmol) are weighed together and mixed with each other in a ball mill (Ernst Hammerschmidt, Vibrator n.M.v. Ardenne). The initially colorless substance mixture takes on a beige color after 60 min. Samples are taken from this mixture and examined by multinuclear NMR spectroscopy. The formation of [(DMAP)₂PO₂]⁺ is detected after only 1 h and the only phosphate-containing product in the ³¹P NMR spectrum (³¹P NMR (CD₃CN, 300 K, δ in ppm): −15.7 (1P, s), which is confirmed by a further sample after 7 h).

### Example 5c): Reaction With Tf₂O in Pyridine Under Acid Catalysis

Potassium phosphate (500 mg, 2.36 mmol) is prepared and placed in pyridine (approx. 20 ml). Under cooling in an ice bath, Tf₂O (1 ml, 5.89 mmol) is added to the mixture, followed by HOTf (0.02 ml, 0.12 mmol). After stirring for 24 h at room temperature, a probe is taken and examined by NMR spectroscopy. The formation of [(Pyr)₂PO₂]⁺ is detected as the only phosphorus-containing product in the ³¹P NMR spectrum (³¹P NMR (pyridine, C₆D₆ capillary, 300 K, δ in ppm): −15.3 (1P, s)).

### Example 6: Reaction of Na₃P₃O₉ (Sodium Trimetaphosphate) With Tf₂O in Pyridine

Sodium trimetaphosphate (Na₃P₃O₉; 40 mg, 0.13 mmol) is suspended in 2 ml of pyridine, and Tf₂O (110 mg, 0.39 mmol) is slowly added. The reaction mixture is heated for 12 h at 40° C. After cooling to room temperature, a sample is taken and examined by multinuclear NMR spectroscopy. The formation of [(Pyr)₂PO₂]⁺ is detected as the only phosphorus-containing product in the ³¹P NMR spectrum (³¹P NMR (pyridine, C₆D₆ capillary, 300 K, δ in ppm): −15.3 (1P, s); ³¹P NMR spectrum is attached in the appendix; FIG. 11).

### Example 7: Reaction of (P₂O₅)ₓ (Phosphorus Pentoxide) With Tf₂O in Pyridine

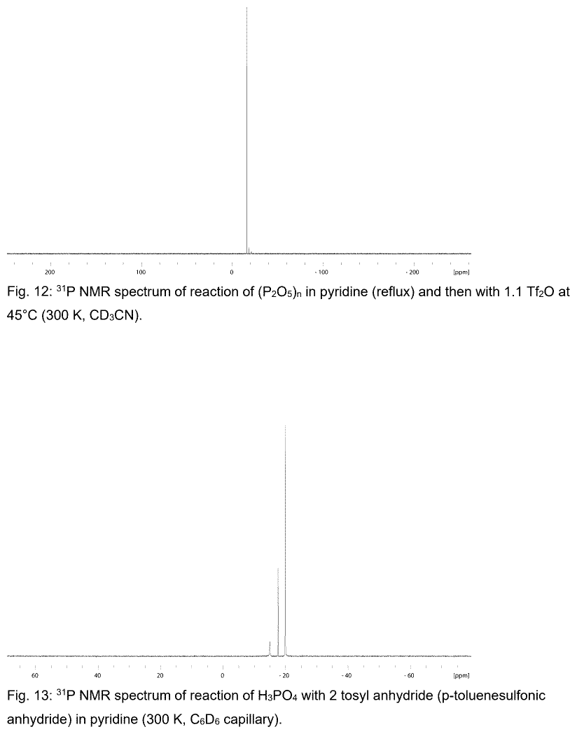

(P₂O₅)ₓ (2 g, 14.18 mmol; Alfa Aesar, 98%, Product No. A13348) is suspended in 10 ml of pyridine and refluxed for 20 h. After cooling to 0° C., Tf₂O (4.37 g, 15.49 mmol) is slowly added. The dark reaction mixture is stirred for 72 h at 45° C., giving rise to a colorless precipitate. The precipitate is filtered, washed with pyridine, and then vacuum-dried. The colorless solid obtained is examined by multinuclear NMR spectroscopy, and the ³¹P NMR spectrum shows clean formation of the triflate salt [(Pyr)₂PO₂]⁺ as the only product. Yield: 9.75 g (93%). (³¹P NMR (CD₃CN, 300 K, δ in ppm): −15.7 (1P, s); ³¹P NMR spectrum is attached in the appendix; FIG. 12).

### Example 8: Reaction of H₃PO₄ With p-Toluenesulfonic Anhydride in Pyridine

H₃PO₄ (60 mg, 0.61 mmol) is suspended in 2 ml of pyridine, and p-toluenesulfonic anhydride (437 mg, 1.34 mmol) is slowly added. The reaction mixture is stirred for 12 h at room temperature. A sample is taken and examined by multinuclear NMR spectroscopy. The formation of [(Pyr)₂PO₂]⁺ is detected in the ³¹P NMR spectrum (³¹P NMR (pyridine, C₆D₆ capillary, 300 K, δ in ppm): −15.3 (1P, s); cf. FIG. 13).

### Example 9: Reactions of (L_{N})₂PO₂[OTf] With Alcohols and Alcoholates

### Example 9a): Reaction of (DMAP)₂PO₂[OTf] With MeOH

(DMAP)₂PO₂[OTf] (30 mg, 0.065 mmol) is dissolved in a mixture of CH₃CN and MeNO₂ (approx. 1 ml), and 2 drops of dry MeOH are added to the mixture. The reaction mixture is stirred over night and examined by NMR spectroscopy. The ³¹P NMR spectrum shows the selective formation of dimethyl phosphate [(MeO)₂PO₂⁻] (³¹P NMR (CH₃CN, MeNO₂, C₆D₆ capillary, 300 K, δ in ppm): −4.6 (1P, s)).

### Example 9b): Reaction of (DMAP)₂PO₂[OTf] With PhOH

(DMAP)₂PO₂[OTf] (40 mg, 0.08 mmol) and phenol (17 mg, 0.17 mmol) are suspended in CH₃CN (approx. 1.5 ml) and stirred for 2 days at 40° C. The ³¹P NMR spectrum of the reaction solution shows the selective formation of diphenyl phosphate [(PhO)₂PO₂⁻] (³¹P NMR (CH₃CN, MeNO₂, C₆D₆ capillary, 300 K, δ in ppm): −11.5 (1P, s)).

### Example 9c): Reaction of (Pyr)₂PO₂[OTf] With 2-Ethylhexanol

(Pyr)₂PO₂[OTf] (500 mg, 1.35 mmol) is suspended in 2-ethylhexanol (5 ml) stirred for 3 days at 65° C. The ³¹P NMR spectrum of the reaction solution shows the selective formation of bis(2-ethylhexyl)phosphate [(RO)₂PO₂⁻] (R=2-ethylhexanoyl) (³¹P NMR (neat, C₆D₆ capillary, 300 K, δ in ppm): 2.12 (1P, s)). The 2-ethylhexanol is drawn off in a vacuum, and the residue is taken up in n-hexane (6 ml) and degassed water (1 ml). After separation of the organic phase and subsequent drying in a vacuum, bis(2-ethylhexyl)phosphate is obtained with 97% purity and 81% (347 mg) yield.

### Example 9d): Reaction of (DMAP)₂PO₂[OTf] With KOtBu

A solution of potassium-tert-butanolate (25 mg, 0.22 mmol) in THF (1 ml) is slowly added to a cold (−30° C.) suspension of (DMAP)₂PO₂[OTf] (50 mg, 0.11 mmol) in THF (1 ml), causing the suspension to turn light yellow. After 3 h, the ³¹P NMR spectrum of the reaction solution shows complete conversion to the corresponding di-tert-butyl phosphate [(tBuO)₂PO₂⁻] (³¹P NMR (THF, C₆D₆ capillary, 300 K, δ in ppm): −5.9 (1P, s)).

### Example 9e): Reaction of (Pyr)₂PO₂[OTf] With BINOL

(Pyr)₂PO₂[OTf] (200 mg, 0.54 mmol) and BINOL (155 mg, 0.54 mmol) are weighed together and suspended in pyridine (5 ml). The reaction mixture is then stirred for 12 h at room temperature. After 12 h, the ³¹P NMR spectrum of the reaction solution shows complete and clean conversion to the corresponding BINOL phosphate (³¹P NMR (pyridine, C₆D₆ capillary, 300 K, δ in ppm): 6.5 ppm (1P, s)). The aqueous workup provides the clean product in 88% yield.

### Example 9f): Reaction of (Pyr)₂PO₂[OTf] With HOCH₂CF₃

(Pyr)₂PO₂[OTf] (185 mg, 0.5 mmol) and 2,2,2-trifluoroethanol (110 mg, 1.1 mmol) are weighed together and suspended in pyridine (2.5 ml). The reaction mixture is stirred for 12 h at room temperature. After 12 h, the ³¹P NMR spectrum of the reaction solution shows complete and clean conversion to the corresponding bis-(trifluoroethyl)phosphate [(CF₃CH₂O)₂PO₂⁻] (³¹P NMR (THF, C₆D₆ capillary, 300 K, δ in ppm): −2.8 (1P, s)). The aqueous workup provides the clean product.

### Example 10: Reaction of (DMAP)₂PO₂[OTf] With PhMgBr

To a cold (−80° C.) suspension of (DMAP)₂PO₂[OTf] (60 mg, 0.13 mmol) in CH₂Cl₂ (3 ml), 0.27 ml of a 1 M THF solution of phenylmagnesium bromide (0.27 mmol) is added. The reaction mixture is stirred overnight, giving rise to a brown, clear solution. NMR examination of the reaction solution shows the formation of diphenylphosphinate [(Ph)₂PO₂⁻] (³¹P NMR (CD₃CN, 300 K, δ in ppm): 14.8 (1P, s)).

### Example 11: Reactions of (L_{N})₂PO₂[OTf] With Amines

### Example 11a): Reaction of (Pyr)₂PO₂[OTf] With Sodium Triazolide

To a suspension of sodium triazolide (74 mg, 0.81 mmol) in CH₃CN (2 ml), solid (Pyr)₂PO₂[OTf] (150 mg, 0.40 mmol) is added, and the reaction mixture is stirred for an additional 2 h. The colorless suspension is filtered, and the solid is washed with CH₃CN and then vacuum-dried. The solid is examined by multinuclear NMR spectroscopy, thus confirming formation of the corresponding (triazole)₂PO₂⁻. The ³¹P NMR spectrum shows two different isomers (³¹P NMR (DMSO-d₆, 300 K, δ in ppm): −22.3 (1P, s; 85%), −24.4 (1P, s; 15%)).

### Example 11b): Reaction of (Pyr)₂PO₂[OTf] With Sodium Imidazolide

To a suspension of sodium imidazolide (54 mg, 0.54 mmol) in CH₃CN (2 ml), solid (Pyr)₂PO₂[OTf] (100 mg, 0.27 mmol) is added, and the reaction mixture is stirred for an additional 2 h. The colorless suspension is filtered, and the solid is washed with CH₃CN and then vacuum-dried. The solid is examined by multinuclear NMR spectroscopy, and formation of the corresponding (imidazole)₂PO₂⁻ is confirmed. The ³¹P NMR spectrum shows two different isomers (³¹P NMR (DMSO-d₆, 300 K, δ in ppm): −20.8 (1P, s; 11%), −21.4 (1P, s; 89%)).

### Example 11c): Reaction of (Pyr)₂PO₂[OTf] With Sodium Pyrazolide

To a suspension of sodium pyrazolide (49 mg, 0.54 mmol) in CH₃CN (2 ml), solid (Pyr)₂PO₂[OTf] (100 mg, 0.27 mmol) is added, and the reaction mixture is stirred for an additional 12 h. The colorless suspension is filtered, and the solid is washed with CH₃CN and then vacuum-dried. The solid is examined by multinuclear NMR spectroscopy, and the formation of the corresponding (pyrazole)₂PO₂⁻ is confirmed (³¹P NMR (DMSO-d₆, 300 K, δ in ppm): −18.2 (1P, s)).

### Example 11d): Reaction of (Pyr)₂PO₂[OTf] With NH₃

(Pyr)₂PO₂[OTf] (100 mg, 0.27 mmol) is dissolved in CH₃CN (2 ml), and NH₃ 0.54 ml (0.5 M in dioxane) is added. The reaction mixture is stirred for an additional 12 h. The colorless suspension is filtered, and the solid is washed with CH₃CN and then vacuum-dried. The solid is examined by multinuclear NMR spectroscopy, showing the formation, among other substances, of (NH2)₂PO₂⁻ (³¹P NMR (DMSO-d₆, 300 K, δ in ppm): −0.3 (1P, pent. ²J_{PH}=8 Hz)).

### Example 12: Reactions of (L_{N})₂PO₂[OTf] to Form Asymmetrically Substituted Products

### Example 12a): Reaction of (Pyr)₂PO₂[OTf] With an Equivalent Quinuclidine

(Pyr)₂PO₂[OTf] (50 mg, 0.13 mmol) is suspended in THF (2 ml), and solid quinuclidine (40 mg, 0.35 mmol) is added. The reaction mixture is stirred for an additional 12 h. The colorless suspension is filtered, and the solid is washed then vacuum-dried. The solid is examined by multinuclear NMR spectroscopy and shows the formation of the mixed/substituted derivative (quin)(Pyr)PO₂⁺ (³¹P NMR (CD₃CN, 300 K, δ in ppm): −3.3 (1P, s)).

### Example 12b): Reaction of (Pyr)₂PO₂[OTf] With Choline Chloride and n-tetradecan-1-ol

The compound (Pyr)₂PO₂[OTf] (2.20 g, 5.90 mmol) and choline chloride (826 mg, 5.90 mmol) are weighed together and suspended in pyridine (12 ml). The reaction mixture is stirred for 48 h at room temperature, and n-tetradecan-1-ol (1.14 g, 5.3 mmol) is added. After a further 24 h, all of the volatile components are removed under a vacuum to obtain a brown powder. The product is isolated by column chromatography with an eluent mixture of CHCl₃/MeOH/NH₃ (25%). The remaining ammonium salt is extracted with CH₃CN, and a further drying step yields the product as a colorless powder as NH₄[Cl]-cocrystallate with a 53% (1.35 g) yield. The solid is examined by multinuclear NMR spectroscopy and shows the formation of the mixed-substituted derivative.

¹H NMR (D₂O, δ in ppm): 0.81 (3H, t, ³J_{HH}=6.9 Hz, H17), 1.26-1.16 (20H, m, H7-H14), 1.33-1.26 (2H, m, H6), 1.56 (2H, quin, ³J_{HH}=6.8 Hz, H5), 3.18 (9H, s, H3), 3.64-3.58 (2H, m, H2), 3.78 (2H, pseudo q, ³J_{HP}=6.5 Hz, ³J_{HH}=6.5 Hz, H4), 4.22 (2H, s(br), H1); ³¹P NMR (D₂O, δ in ppm): 0.6 (quin, ³J_{PH}=5 Hz).

### Example 12c): Reaction of (Pyr)₂PO₂[OTf] With Choline Chloride and (R)-Solketal

(Pyr)₂PO₂[OTf] (3.70 g, 10.0 mmol) and choline chloride (1.40 g, 10.0 mmol) are suspended in pyridine and stirred for 20 h at room temperature. The mixture is then mixed with (R)-Solketal (1.32 g, 10.0 mmol) and further stirred for several days at 40° C. in an oil bath, in which it becomes sharply more clear. After cooling to room temperature, all volatile components are removed in a vacuum to obtain a reddish oil. The product is isolated by column chromatography with an eluent mixture of CHCl₃/MeOH/NH₃ (25%). After drying in a vacuum, the product is obtained as a colorless powder as NH₄[Cl]-cocrystallate with a 52% (1.91 g) yield. The solid is examined by multinuclear NMR spectroscopy and shows the formation of the mixed-substituted derivative.

¹H NMR (CD₃OD, δ in ppm): 1.33 (s, 3H, H8/8′), 1.39 (s, 3H, H8/8′), 3.23 (s, 9H, H1), 3.65 (m, 2H, H2), 3.82 (dd, 1H, ²J_{HH}=8.3 Hz, ³J_{HH}=6.1 Hz, H6), 3.88 (m, 2H, H4), 4.07 (dd, 1H, ²J_{HH}=8.3 Hz, ³J_{HH}=6.6 Hz, H6), 4.25-4.34 (m, 3H, H3/5); ³¹P NMR (CD₃OD, δ in ppm): −0.5 (quin, 1P ³J_{PH}=6.6 Hz).

### Example 12d): Reaction of (Pyr)₂PO₂[OTf] With Sodium Azide and 2′,3′-Isopropylidene Uridine

(Pyr)₂PO₂[OTf] (370 mg, 1.0 mmol) and NaN₃ (65 mg, 1.0 mmol) are suspended in CH₃CN and stirred for 4 h at room temperature, causing a voluminous colorless precipitate to be deposited. A solution of 2′,3′-isopropylidene uridine (284 mg, 1.0 mmol) in pyridine is then added to the suspension, and the resulting mixture is stirred for another 16 h, resulting in a virtually clear solution. After removal of all volatile components in a vacuum, the residue obtained is washed with CH₃CN and dried in a vacuum in order to obtain 334 mg of the raw product as sodium salt. The raw product is then purified by column chromatography with a CHCl₃/MeOH mixture. After removal of all volatile components from the product-containing fractions, the free acid is obtained as a colorless hygroscopic powder. Yield 29% (111 mg). The solid is examined by multinuclear NMR spectroscopy and shows the formation of the mixed-substituted derivative.

¹H NMR (DMSO-d₆, δ in ppm): 1.29 (s, 3H, H7′/8′), 1.49 (s, 3H, H7′/8′), 3.83-3.96 (m, 2H, H5′), 4.15-4.19 (m, 1H, H4′), 4.77 (dd, 1H, ³J_{HH}=6.4/3.7 Hz, H3′), 4.96 (dd, 1H, ³J_{HH}=6.4/2.4 Hz, H2′), 5.60 (d, 1H, ³J_{HH}=8.1 Hz, H5), 5.83 (d, 1H, ³J_{HH}=2.4 Hz, H1′), 7.76 (d, 1H, ³J_{HH}=8.1 Hz, H6), 11.38 (s(br), 1H, H3); ³¹P NMR (DMSO-d₆, δ in ppm): −5.6 (s, 1P).

The product of Example 1 (FIG. 1-3) shows one singlet each in the ³¹P- and ¹⁹F-NMR spectra. The resonance in the ³¹P-NMR spectrum, with its chemical shift of δ(P)=−15.8 ppm, indicates the phosphorus(V) precursor known from the literature (P. Rovnaník, L. Kapička, J. Taraba, M. Černík, Inorg. Chem. 2004, 43, 2435). The resonance in the ¹⁹F-NMR spectrum, with its chemical shift of δ(F)=−79.2 ppm, indicates the triflate anion known from the literature. The chemical shifts in the ¹H-NMR spectrum at δ(H)=7.97 ppm, δ(H)=8.48 ppm and δ(H)=9.16 ppm indicate the presence of the pyridine ligand.

The product of Example 3 (FIGS. 4-6) shows one singlet each in the ³¹P- and ¹⁹F-NMR spectra. The resonance in the ³¹P-NMR spectrum, with its chemical shift of δ(P)=−14.2 ppm, indicates the phosphorus(V) precursor known from the literature (P. Rovnaník, L. Kapička, J. Taraba, M. Černík, Inorg. Chem. 2004, 43, 2435). The resonance in the ¹⁹F-NMR spectrum, with its chemical shift of δ(F)=−78.4 ppm, indicates the triflate anion known from the literature. The chemical shifts in the ¹H-NMR spectrum at δ(H)=4.55 ppm, δ(H)=8.17 ppm and δ(H)=9.66 ppm indicate the presence of the DMAP ligand.

1. A method for synthesizing nitrogenous phosphorus(V) precursors of Formula (I), 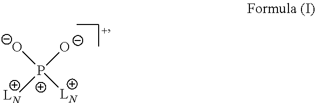
wherein the method comprises the following steps in the order indicated:
a) preparing a phosphate compound;
b) reacting the phosphate compound of step a) with an oxygen acceptor in the presence of a Lewis base L_{N} that is capable of coordination via a nitrogen atom,
wherein the oxygen acceptor is a cation of a sulfonic acid anhydride of Formula (II) and the sulfonic acid anhydride is according to Formula (III), 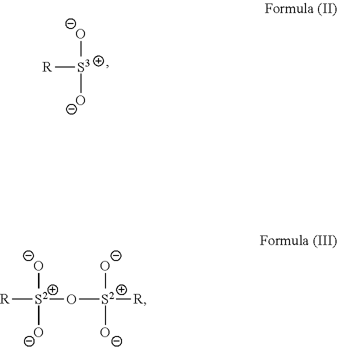
alternatively, according to step b), either
b1) the phosphate compound of step a) is reacted with the sulfonic acid anhydride of Formula (III) in the presence of a Lewis base L_{N}, or
b2) the phosphate compound of step a) is reacted with a reaction product of a sulfonic acid anhydride of Formula (III) with a Lewis base L_{N}, wherein the reaction product is Formula (IV) 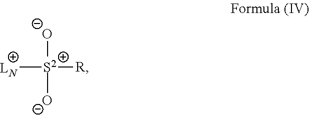
wherein R is an aliphatic or aromatic hydrocarbon radical that can comprise heteroatoms, wherein the number of carbon atoms of the radical R is 1 to 21, and the heteroatoms are selected from the group consisting of oxygen, nitrogen, fluorine, chlorine, bromine, iodine, and mixtures thereof,
wherein the Lewis base L_{N} that is capable of coordination via a nitrogen atom is a nitrogenous heteroaromatic compound which comprises a six-membered heteroaromatic ring comprising a nitrogen atom capable of coordination, and wherein the number of carbon atoms of the Lewis base L_{N} is from 4 to 19.

2. The method as claimed in claim 1, wherein the phosphate compound is selected from the group consisting of orthophosphate salts and acids, polyphosphate salts and acids, metaphosphate salts and acids, salts and acids of further condensed phosphates derivable therefrom, phosphorus pentoxide (P₄O₁₀), and mixtures thereof,
wherein the polyphosphate salts and acids can be described by the Formula PₘO₃ₘ₊₁^{(m+2)-} and wherein: m=2 to 10 000; and
wherein the metaphosphate and salts and acids can be described by the Formula (PO₃⁻)ₙ and wherein: n=3 to 10.

3. The method as claimed in claim 2, wherein the polyphosphate salts and acids can be described by the Formula PₘO₃ₘ₊₁^{(m+2)-} and wherein: m=2 to 10 000; and wherein the metaphosphate salts and acids can be described by the Formula (PO₃⁻)ₙ and wherein the following applies: n=3 to 10.

4. The method as claimed in claim 1, wherein the phosphate compound comprises phosphoric acid.

5. The method as claimed in claim 1, wherein R is an aliphatic hydrocarbon radical with 1 to 6 carbon atoms, which comprises 0 to 3 heteroatoms selected from the group consisting of oxygen, nitrogen and fluorine.

6. The method as claimed in claim 1, wherein R is an aromatic hydrocarbon radical defined by Formula (IIIa), 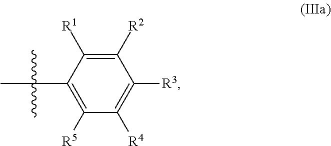
wherein the radicals R¹, R², R³, R⁴, and R⁵ are selected from the following combinations:
R¹, R², R³, R⁴, R⁵=H,
R¹, R², R³, R⁴, R⁵=CH₃,
R¹, R², R³, R⁴=H and R⁵=CH₃,
R¹, R², R³, R⁴=H and R⁵=F,
R¹, R², R³, R⁴=H and R⁵=Cl,
R¹, R², R³, R⁴=H and R⁵=OCH₃,
R¹, R², R³, R⁴=H and R⁵=NO₂,
R¹, R², R³, R⁴=H and R⁵=CF₃,
R¹, R², R⁴=H and R³, R⁵=CH₃,
R², R⁴=H and R¹, R³, R⁵=CH₃,
R², R³, R⁵=H and R¹, R⁴=CH₃, or
R¹, R², R⁴, R⁵=H and R³=CH₃.

7. The method as claimed in claim 5, wherein R is trifluoromethyl.

8. The method as claimed in claim 1, wherein the Lewis base L_{N} comprises one or two six-membered heteroaromatic rings, the Lewis base L_{N} comprises one or two nitrogen atoms capable of coordination per six-membered heteroaromatic ring in the six-membered heteroaromatic ring, and wherein the Lewis base L_{N} comprises a total of one or two nitrogen atoms.

9. The method as claimed in claim 1, wherein the Lewis base L_{N} comprises, independently of each other, one or two nitrogen atoms, zero, one or two oxygen atoms, zero, one, two, three or four heteroatoms, which are selected from the group consisting of fluorine, chlorine, bromine, and iodine, and does not comprise any further heteroatoms.

10. The method as claimed in claim 1, wherein the Lewis base L_{N} is selected from the group consisting of pyridines, picolines, lutidines, collidines, bipyridines, pyridazines, pyrimidines, pyrazines, quinolines and isoquinolines.

11. The method as claimed in claim 1, wherein the Lewis base L_{N} is selected from the group consisting of pyridine, 4-dimethylaminopyridine, and mixtures thereof.

12. The method as claimed in claim 1, wherein the synthesis takes place in an aprotic solvent.

13. The method as claimed in claim 12, wherein the aprotic solvent is pyridine.

14. A method for synthesizing oxyphosphorus compounds, wherein the method comprises the following steps in the order indicated:
c) synthesis of a nitrogenous phosphorus(V) precursor of Formula (I) according to the method as claimed in claim 1;
d) reacting the nitrogenous phosphorus(V) precursor of Formula (I) with a nucleophile.

15. The method as claimed in claim 14, wherein the nucleophile is selected from the group consisting of alcohols, ammonia, primary amines, secondary amines, tertiary amines, azoles, organometallic compounds and fluoride.

16. The method as claimed in claim 1, wherein the phosphate compound is phosphoric acid.

17. The method as claimed in claims 6, wherein R is defined according to Formula (IIIa) and the following applies:
R¹, R², R⁴, R⁵=H and R³=CH₃.
